(19) United States
(12) Patent Application Publication
(10) Pub. No.: US 2018/0317735 A1
(43) Pub. Date: Nov. 8, 2018

(54) DUSTPAN AND BROOM HOUSING ASSEMBLY COMBINATION

(71) Applicant: WISP Industries, Inc., San Marcos, CA (US)

(72) Inventors: Eben W. Dobson, III, San Marcos, CA (US); Lawrence Thad Levine, Easton, CT (US); Harvey Levine, Fairfield, CT (US)

(73) Assignee: WISP Industries, Inc., San Marcos, CA (US)

(21) Appl. No.: 15/803,725

(22) Filed: Nov. 3, 2017

Related U.S. Application Data
(63) Continuation-in-part of application No. 29/602,610, filed on May 2, 2017, now Pat. No. D826503.

(51) Int. Cl. A47L 13/52; A46B 15/00; B25G 3/28

(52) U.S. Cl. CPC A47L 13/52; A46B 2200/302; B25G 3/28; A46B 15/0055

(57) ABSTRACT

The invention comprises a broom that can be detachably coupled to a dustpan for ergonomic and efficient removal of materials in the dustpan into a collection receptacle simply by using one hand to lift the combination, without the need to bend over to pick up the dustpan. In an exemplary embodiment, the dustpan comprises a pair of mushroom head connectors that are received by corresponding keyhole shaped apertures in the broom

### CROSS-REFERENCE TO RELATED APPLICATION

The present application claims priority to co-pending U.S. Design patent application Ser. No. 29/602,610, filed May 2, 2017, and entitled “Dustpan,” the entire disclosure of which is incorporated by reference herein.

### BACKGROUND OF THE INVENTION

### 1. Field of Invention

The present invention relates to a dustpan and broom housing assembly for ease of debris disposal.

### 2. Description of Related Art

The uses of a dustpan to pick up, collect, and remove a mixture of materials, (e.g., dirt, dust, leaves, and other debris or fragmented materials) from a surface, such as a floor, are well known. Various designs have been utilized over the years for making and using dustpans. For example, different designs may utilize one piece or multiple piece constructions, may employ metallic, plastic and/or molded materials, and may show numerous ornamental variations. One common design for dustpans consists of a shallow dustpan body with an open edge or “blade” at the front of the dustpan body, and an elongated pedal or grip attached to the rear of the dustpan body. A pedal extends outwardly from the rear of the dustpan body in a generally parallel or slightly angled direction relative to the surface when the dustpan is placed on the surface. The pedal thus provides a handy and convenient means for manipulating the dustpan during use. However, it is often difficult, cumbersome or inconvenient to bend over and hold the dustpan by the pedal while simultaneously sweeping debris into the dustpan. Additionally, such dustpans do not always effectively keep the entire length of the front edge or blade of the dustpan in contact with the surface during use. As a result, at least a portion of the various materials intended to be swept into such dustpans may be swept underneath the dustpan (or blocked altogether) instead of into the body of the dustpan.

Brooms are used to sweep materials into dustpans. However, current boom designs have no means of lifting a dustpan. Instead, users must use both hands—one hand to hold the broom handle coupled to the broom housing assembly and one hand to hold the dustpan, and then bend over to lift the dustpan and/or tilt it into a collecting receptacle. This may be difficult for elderly or physically restricted people. Thus, conventional broom and dustpan systems are limited and it necessitates a better solution to make removal of materials faster, more effortless and convenient for users.

### SUMMARY OF THE INVENTION

The present invention is directed toward a dustpan and broom housing assembly combination usable for ergonomic and efficient removal of materials from a surface, while standing in an upright position, without the need to bend over and pick up the dustpan. In certain embodiments, the dustpan includes a body, a blade, a rear support, a cross member, and a connector. In alternative embodiments, the broom housing assembly includes a socket, a center member, a side member, a rear member, a head support, and apertures. In other embodiments, the dustpan and broom housing assembly combination includes a means of coupling the broom housing to a pole-like broom handle and a means for coupling the broom housing assembly to the dustpan.

In one embodiment, the dustpan includes: a body, and a cross member coupled to the body, and means, disposed on the cross member, for detachably coupling the dustpan to a broom. The means for detachably coupling includes a plurality of connectors.

In one embodiment of the dustpan, each of the plurality of connectors includes a mushroom shaped head and a stem.

In yet another embodiment of the dustpan, each of the plurality of connectors are disposed on opposing ends of the cross member.

In yet another embodiment, the dustpan includes a plurality of connectors that are integrally formed with the cross member. In yet an alternative embodiment, the dustpan a plurality of connectors are formed as separate structures from the cross member.

In one embodiment of the invention, the dustpan includes the means for detachably coupling via an adhesive coating. Alternatively, the dustpan, in another embodiment, includes the means for detachably coupling via a magnet.

In an embodiment, a broom includes a socket, a body coupled to the socket, and a bristle array coupled to the body; and a means, disposed on the body, for detachably coupling the body to a dustpan.

In another embodiment, the broom includes the means for detachably coupling comprising a plurality of apertures. More specifically, each of the apertures includes a circular portion and a slot portion.

In an alternative embodiment, the broom includes a plurality of apertures disposed on a portion of the body adjacent to the bristle array.

In yet another embodiment, the broom includes the means for detachably coupling via an adhesive coating. Alternatively, the broom includes the means for detachably coupling via a magnet.

In one preferred embodiment, a broom and dustpan system includes a dustpan, a broom, and a means for detachably coupling the dustpan and the broom together.

In an embodiment, the system includes the means for detachably coupling the dustpan and the broom together comprising a plurality of connectors and a plurality of apertures.

In yet another embodiment of the system, each of the plurality of connectors include a mushroom shaped head and a stem, and each of the apertures include a circular portion and a slot portion.

In another embodiment, the system includes the means for detachably coupling the dustpan and the broom together comprising one or more adhesive coatings.

In an alternative embodiment, the system includes the means for detachably coupling the dustpan and the broom together comprising one or more magnets.

Advantages of the invention include the ergonomic and efficient removal of materials in the dustpan into a collection receptacle simply by using one hand to lift the combination, without the need to bend over to pick up the dustpan. This tool would be particularly useful for users with physical restrictions who cannot bend over to lift a dustpan.

The foregoing, and other features and advantages of the invention, will be apparent from the following, more particular description of the detailed embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 is a perspective view of an embodiment of a dustpan having features of the present invention;

FIG. 2 is a top view of the dustpan illustrated in FIG. 1;

FIG. 3 is a front view of the dustpan illustrated in FIG. 1;

FIG. 4 is a rear view of the dustpan illustrated in FIG. 1;

FIG. 5 is a side view of the dustpan illustrated in FIG. 1, shown in a resting position;

FIG. 6 is a sectional view of the dustpan taken on line 7-7 in FIG. 2, shown in a resting position;

FIG. 7 is a side view of the dustpan illustrated in FIG. 1, shown in a depressed position;

FIG. 8 is a perspective view of an embodiment of a broom housing assembly, and bristle assembly shown in phantom, having features of the present invention;

FIG. 9 is a top view of the broom housing assembly illustrated in FIG. 8, with the bristle assembly shown in phantom;

FIG. 10 is a bottom view of the broom housing assembly illustrated in FIG. 8, with the bristle assembly shown in phantom;

FIG. 11 is a perspective view of the assembled dustpan and broom combination according to an embodiment of the present invention;

FIG. 12 is a side view of the unassembled dustpan and broom combination, showing an aperture for the connector on the broom housing assembly in phantom, according to an embodiment of the present invention;

FIG. 13 is a sectional view of the assembled dustpan and broom combination, showing an enlarged view of the aperture coupled to the connector, according to an embodiment of the present invention; and

FIG. 14 is another sectional view of the assembled dustpan and broom combination according to an embodiment of the present invention.

### DETAILED DESCRIPTION OF PREFERRED EMBODIMENTS

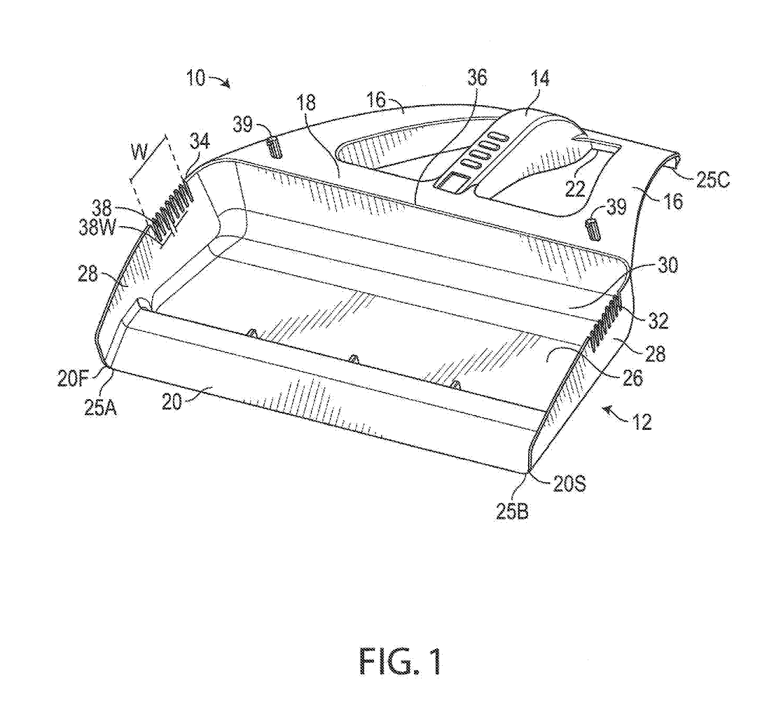

Preferred embodiments of the present invention and their advantages may be understood by referring to FIGS. 1-14, wherein like reference numerals refer to like elements. The invention describes a dustpan 10, a broom housing assembly 50, and a dustpan and broom combination 60. Also, reference to a broom housing assembly also includes reference to a broom or a similar tool. Henceforward, the combination 60 refers to both the dustpan 10 and the broom housing assembly 50 as described herein.

FIG. 1 is a perspective view of the dustpan 10 according to an embodiment of the present invention. The dustpan 10 includes a body 12, a pedal 14, a pair of side members 16, one or more cross members 18, a pair of connectors 39, a blade 20 and a rear support 22. Alternatively, the dustpan 10 can have a different design. For example, in certain non-exclusive alternative embodiments, the dustpan 10 includes a different number of side members 16, i.e., zero, one or more than two side members 16. In another example, the dustpan 10 includes a different number of connectors 39, i.e., three or more connectors 39. The connectors 39 are used to detachably couple the dustpan 10 to the broom housing assembly 50.

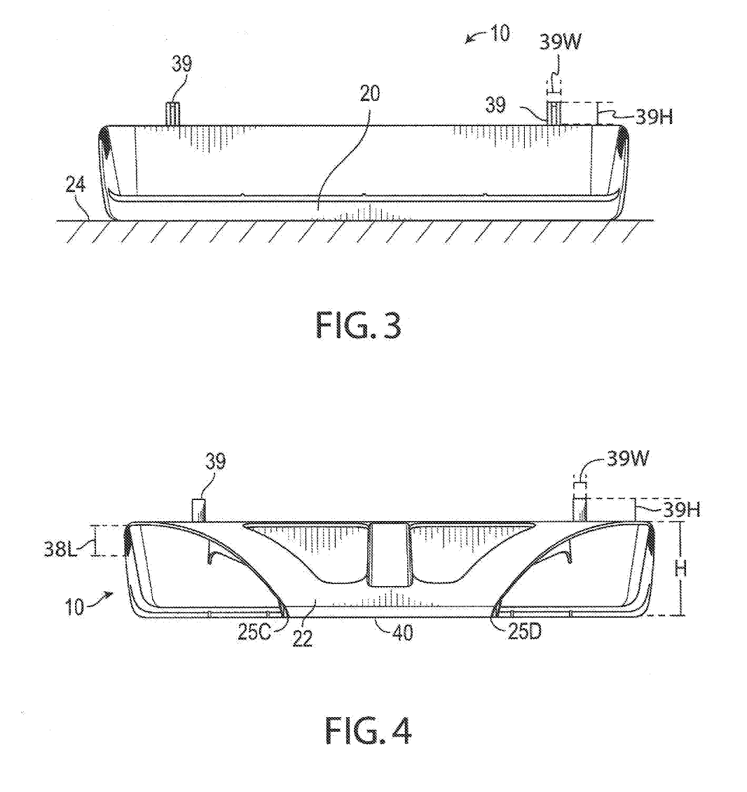

As an overview, the dustpan 10 is uniquely designed to enable the user to maintain the blade 20 of the dustpan 10 in firm and continuous contact with a surface 24 (illustrated in FIG. 3) to be cleaned during use. More particularly, as illustrated and described herein, the dustpan 10 includes four individual contact points i.e. a first contact point 25A, a second contact point 25B, a third contact point 25C, and a fourth contact point 25D (illustrated in FIG. 1 and FIG. 4), which are at or near the ends 20F, 20S of the blade 20 and at or near the ends of the rear support 22, respectively, at which contact with the surface 24 is consistently maintained. Stated in another manner, the dustpan 10 maintains contact with the surface 24 at two spaced apart areas of the dustpan 10, i.e. the blade 20 and the rear support 22, at all times during use of the dustpan 10. As illustrated and described herein, the blade 20 can constitute and/or include the forward most portion of the dustpan 10. Additionally, in certain embodiments, the rear support 22 can constitute and/or include the rearward most portion of the dustpan 10.

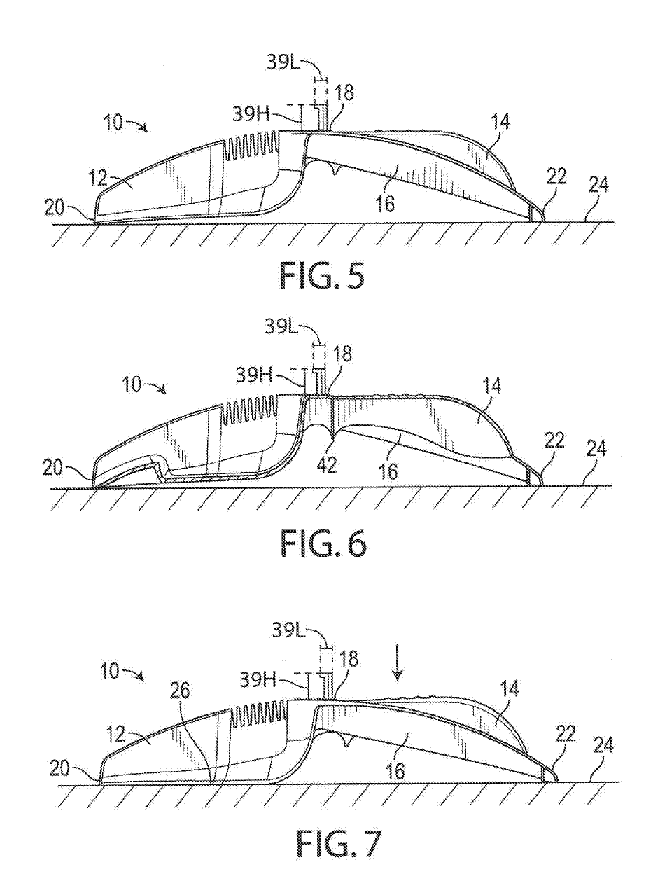

Moreover, the user can apply downward pressure (toward the surface 24) on the dustpan 10 between the rear support 22 and the blade 20 (with the user's foot, for example), e.g., near the rear support 22, which thereby causes the blade 20 to press more firmly downward against the surface 24 to be cleaned. Stated in another manner, when the dustpan 10 is positioned on the surface 24 during use, downward pressure on the dustpan 10 moves the dustpan 10 from a resting position (e.g., as illustrated in FIG. 5 and FIG. 6 and a depressed position (e.g., as illustrated in FIG. 7). For example, the downward pressure can be applied to the raised pedal 14 or either of the side members 16 to move the dustpan 10 from the resting position to the depressed position. With this design, the user does not need to bend over and use his/her hand to tilt the blade 20 into the surface 24 as is often required with conventional dustpans.

The body 12 of the dustpan 10 is adapted to receive the dirt, leaves, dust and various other debris or materials that are desired to be removed from the surface 24. As illustrated, the body 12 can be designed in a manner somewhat similar to a standard dustpan. For example, as shown in FIG. 1, the body 12 of the dustpan 10 can include a base 26, a pair of opposed sides 28, and a back 30 that cooperate to define a receptacle for receiving the dirt, leaves, dust and other materials that are desired to be removed from the surface 24.

In certain embodiments, the body 12 can be formed from a moldable plastic, from various metallic materials, or from other suitable materials. Further, the body 12, i.e. the base 26, the sides 28 and the back 30, can be integrally formed so as to avoid any seams within which the dirt and debris may get trapped during use.

The design of the connector 39 can be varied to suit the specific design requirements of the combination 60. In certain embodiments, the connector 39 is formed from a moldable plastic, from various metallic or rubberized materials, magnets, and/or from other suitable materials which can be similar to or different than the materials used to form the body 12 of the dustpan 10. Additionally, the connector 39 can have a different design and/ or the connector 39 can be positioned at a different location on the dustpan 10. In alternative embodiments, the connector 39 is integrally formed with the cross member 18 or the side member 16 so as to avoid dislodging of the connector 39 during use.

In the embodiment illustrated in FIG. 1, a pair of the connector 39 are located on the cross member 18 of the dustpan 10. Furthermore, in this embodiment, a pair of connector 39 are integrally formed with the cross member 18 at opposing ends of the cross member 18. Alternatively, in other non-exclusive embodiments, a plurality of the connector 39 is integrally formed with the side member 16 and/or any other different area of the dustpan 10.

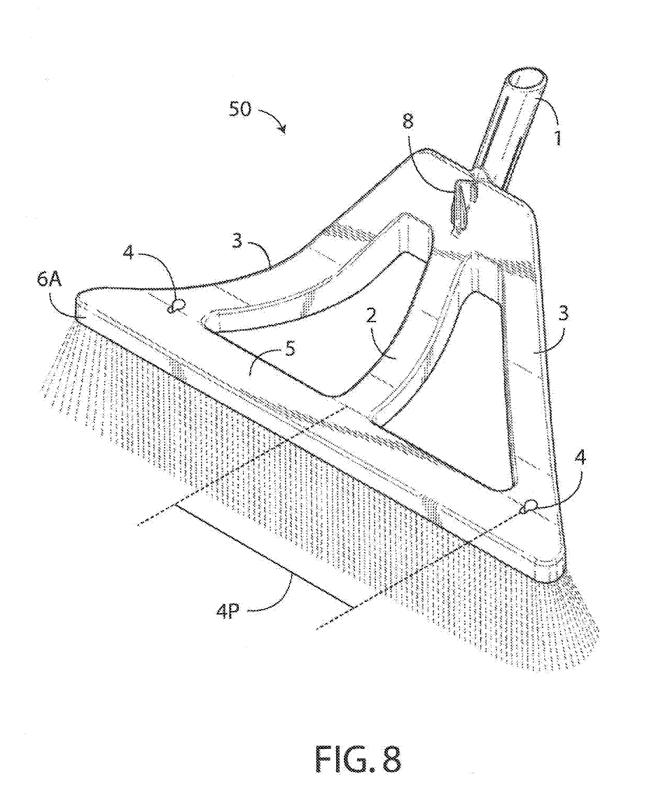

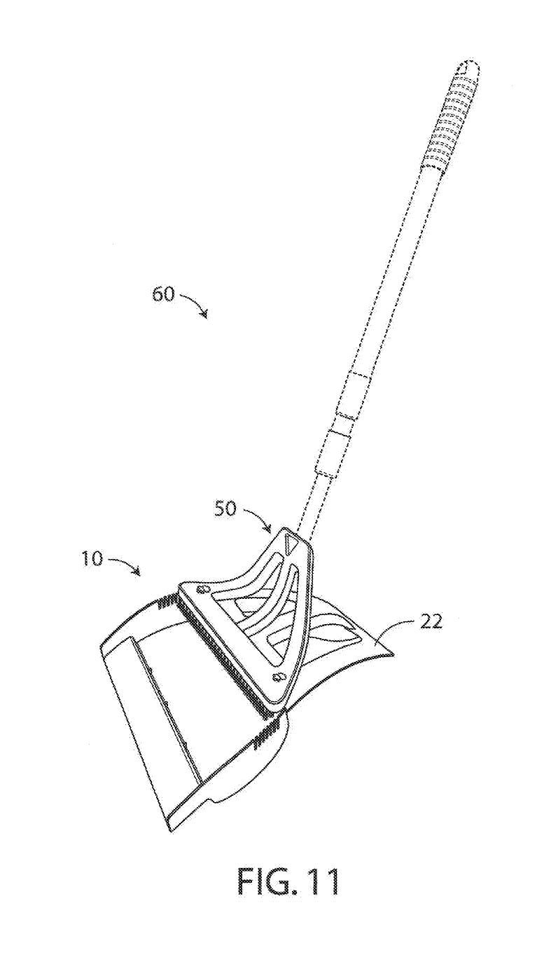

Further, as illustrated in FIG. 1, the connector 39 is formed in a specific shape that properly fits into the aperture 4 on the broom housing assembly 50 (as illustrated in FIG. 8) with which the dustpan 10 is being used. Moreover, as illustrated and described herein, the unique design of the connector 39 permits a more secure means for coupling the dustpan 10 to the broom housing assembly 50 in the combination 60 (as illustrated in FIG. 11) for lifting a dustpan. For example, the connector 39 is shaped as a mushroom like head and stem, and the aperture 4 is shaped as a keyhole opening comprising a circular opening portion and a slot portion. The width of the slot portion is smaller than the diameter of the circular opening portion and the diameter of the mushroom head of the connector, but bigger than the diameter of the stem. The mushroom head fits through the circular opening portion, but once slid into the slot portion, cannot fit back through the slot portion. This enables the dustpan 10 to be secured (at least temporarily, i.e., detachably coupled) to the broom 50. To unsecure the dustpan 10 from the broom 50, the mushroom head is slid from the slot portion to the circular portion and then moved through the circular portion to release the dustpan 10 from the broom 50. In certain embodiments, the aperture 4 has a different orientation on the rear member 5, whereby the slot portion and the circle portions are positioned differently.

Alternatively, the connector 39 can be manufactured as a separate structure, and be attached to the cross member 18 and/or a different area of the dustpan 10 by any suitable manner. In non-exclusive other embodiments, the connector 39 comprises an adhesive coating, e.g., sticky pad, gel adhesive, glue, tape, rubber cement, or another similar material. Additionally, the connector 39 has an adhesive coating on one or more selected surfaces of the connector, wherein the adhesive coating maintains its adhesive property for multiple uses, e.g., attaching to more than one dustpan. Such a connector 39 with an adhesive coating provides a means for permanently or detachably coupling the connector 39 to the dustpan 10. Furthermore, such a connector 39 with an adhesive coating provides a means for permanently or detachably coupling the connector 39 of the dustpan 10 to the aperture 4 of the broom housing assembly 50. Also, connector 39 separate structures permit the addition of connectors to a dustpan without a means for coupling to the broom housing assembly 50 (as illustrated in FIG. 8 and FIG. 11) or the addition of connectors to another dustpan entirely that is of a different size (not illustrated).

Sometimes during use, some dust or debris may get stuck within a plurality of bristles of the brush or broom (not illustrated) that is being used with the dustpan 10. Thus, as illustrated, in certain embodiments, the dustpan 10 includes a bristle cleaner 32 that is utilized to remove any such dust or debris from the bristles of the brush or broom that is being used with the dustpan 10. To effectively remove such dust or debris from the bristles of the brush or broom, the bristles are simply moved through the bristle cleaner 32, which dislodges the dust or debris from the bristles so that they can be disposed of with the rest of the materials being removed from the surface 24.

The design of the bristle cleaner 32 can be varied to suit the specific design requirements of the dustpan 10. For example, in the embodiment illustrated in FIG. 1, the bristle cleaner 32 is provided in the form of a comb feature, which can be formed into a top edge 34 of the sides 28 of the body 12 of the dustpan 10. Alternatively, the bristle cleaner 32 can have a different design and/or the bristle cleaner 32 can be positioned at a different location within the dustpan 10.

In the embodiment illustrated in FIG. 1, a separate bristle cleaner 32 is included at the top edge 34 of both sides 28 of the body 12 of the dustpan 10. Alternatively, in other non-exclusive embodiments, the bristle cleaner 32 can be included along the top edge 34 of only one of the sides 28, and/or the bristle cleaner 32 can also be formed along a top edge 36 of the back 30 of the body 12 of the dustpan 10.

Additionally, the bristle cleaner 32 can be of any suitable size, depending on the specific requirements of the dustpan 10. For example, in certain embodiments, the bristle cleaner 32 can have a width W that can be between approximately one inch and five inches. More specifically, in certain non-exclusive alternative embodiments, the width W of the bristle cleaner 32 can be approximately 1.0, 1.5, 2.0, 2.5, 3.0, 3.5, 4.0, 4.5 or 5.0 inches. Still alternatively, the width W of the bristle cleaner 32 can be another suitable value that is greater than five inches, less than one inch, or some other value between one inch and five inches.

Further, as illustrated in FIG. 1, the bristle cleaner 32 includes a plurality of tines 38 that can be used to effectively and efficiently dislodge the dust or debris from the bristles of the brush or broom with which the dustpan 10 is being used. Moreover, as illustrated and described herein, the unique design of the bristle cleaner 32, i.e., the unique design of the tines 38, is better able to remove the unwanted dust or debris along the full length of the bristles of the brush or broom.

The tines 38 on the bristle cleaner 32 can have any suitable size, i.e. any suitable length 38L (illustrated in FIG. 4) and width 38W, depending on the requirements of the bristle cleaner 32 and/or the dustpan 10. For example, in one non-exclusive alternative embodiment, the tines 38 can have a length 38L that extends approximately one-third a height H (illustrated in FIG. 4) of the body 12, i.e., of the sides 28 of the body 12, of the dustpan 10. In non-exclusive, alternative embodiments, the tines 38 can have a length 38L that extends approximately one-fourth, one-half, two-thirds, or three-fourths of the height H of the body 12 of the dustpan 10. Still alternatively, the tines 38 can have a length 38L that extends greater than three-fourths or less than one-fourth the height H of the body 12 of the dustpan 10, or another suitable value between one-fourth and three-fourths the height H of the body 12 of the dustpan 10.

Additionally and/or alternatively, the tines 38 can have a certain length 38L regardless of the overall height H of the body 12 of the dustpan 10. For example, in certain non-exclusive alternative embodiments, the length 38L of the tines 38 can be approximately 0.25, 0.5, 0.75, 1.0, 1.25, 1.5, 1.75 or 2.0 inches. Still alternatively, the length 38L of the tines 38 can be less than 0.25 inches, greater than 2.0 inches, or another suitable value between 0.25 and 2.0 inches.

Further, the width 38W of each of the tines 38 can be varied. For example, in certain non-exclusive alternative embodiments, the width 38W of each of the tines 38 can be approximately one-sixteenth, one-eighth, three-sixteenths, one-fourth, five-sixteenths, or three-eighths inches. Still alternatively, the width 38W of each of the tines 38 can be less than one-sixteenth inches, greater than three-eighths inches, or another suitable value between one-sixteenth and three-eighths inches. Moreover, the tines 38 can have a ratio of the length 38L to the width 38W that can be approximately 1.5:1, 2.0:1, 2.5:1, 3.0:1, 4.0:1, 5.0:1, 6.01, 8.0:1, 10.0:1, 12.0:1, or any other suitable ratio.

Still further, the width 38W and the spacing of the tines 38 can be such that the bristle cleaner 32 includes approximately three, four, five, six, seven or eight tines 38 per inch of the width W of the bristle cleaner 32. Alternatively, the bristle cleaner 32 can include a different number of tines 38 per inch.

The pedal 14 extends in a generally rearward direction away from the body 12 of the dustpan 10. More particularly, in this embodiment, the pedal 14 extends in a rearward direction from at or near the center of the back 30 of the body 12 of the dustpan 10. Additionally, in this embodiment, the pedal 14 extends substantially perpendicularly away from the back 30 of the body 12 of the dustpan 10. Alternatively, the pedal 14 can be positioned in a different orientation relative to the body 12 of the dustpan 10 than that shown in the Figures.

The pedal 14 can be sized and shaped so that the pedal 14 can be easily grasped and gripped by the user of the dustpan 10. Further, as discussed herein, the user of the dustpan 10 can apply downward pressure on the pedal 14, e.g., with the user's foot, to maintain the blade 20, and the rear support 22, in firm and/or continuous contact with the surface 24 during cleaning of the surface 24.

Somewhat similarly, the side members 16 extend in a generally rearward direction away from the body 12 of the dustpan 10. More particularly, in this embodiment, each of the side members 16 extend in a generally rearward direction from at or near the junction between the cross member 18, the back 30 and/or one of the sides 28 of the body 12 of the dustpan 10. Additionally, in this embodiment, each of the side members 16 can be angled in a somewhat inward direction as the side members 16 extend away from the body 12 of the dustpan 10. Alternatively, or in addition, the side members 16 can be angled somewhat toward each other and/or toward the pedal 14 as the side members 16 extend rearward toward the rear support 22. As discussed herein, during use, the user can apply downward pressure on one or both of the side members 16, e.g., with the user's foot, to maintain the blade 20, and the rear support 22, in firm and/or continuous contact with the surface 24 during movement of debris from the surface and into the dustpan 10.

It should be noted that, as described herein, maintaining the blade 20 and the rear support 22 in firm contact with the surface 24 during cleaning of the surface 24 can occur by biasing, and thereby maintaining, the four contact points 25A-25D against the surface 24 during cleaning of the surface 24.

The cross member 18 connects the pedal 14 with the side members 16, further connects the connectors 39 with the side members 16, and further connects the pedal 14 and the side members 16 to the body 12 of the dustpan 10. In particular, in the embodiment illustrated in FIG. 1, the cross member 18 extends substantially horizontally (i.e. relative to the surface 24, during use) away from the back 30 of the body 12 of the dustpan 10 near the top edge 36 of the back 30. In one embodiment, the cross member 18 can be integrally formed with the body 12, the pedal 14 and the side members 16 of the dustpan 10. Alternatively, the cross member 18 can be manufactured as a separate structure, and can be coupled to one or more of the body 12, the pedal 14 and the side members 16 of the dustpan 10 by any suitable manner.

The blade 20 is coupled to the body 12 of the dustpan 10, e.g., to the base 26 and to one or both of the sides 28 of the body 12 of the dustpan 10. In the embodiment illustrated in FIG. 1, the blade 20 is positioned generally forwardly, e.g., away from the back 30, from the base 26 of the body 12 of the dustpan 10. Additionally, the blade 20 can be angled downward slightly, i.e. toward the surface 24, as it extends forwardly from the body 12 of the dustpan 10, to allow for better contact between the blade 20 and the surface 24 during use. In certain embodiments, the blade 20 is integrally formed with the body 12 of the dustpan 10.

As noted above, the blade 20, which can constitute and/or include the forward most portion of the dustpan 10, includes the first contact point 25A and the second contact point 25B between the dustpan 10 and the surface 24. In the embodiment illustrated in FIG. 1, the first contact point 25A is at or near a first end 20F of the blade 20, and the second contact point 25B is at or near a second end 20S of the blade 20. In some embodiments, a center region of the blade 20, i.e. between the first contact point 25A and the second contact point 25B, may be slightly spaced apart from the surface 24 when no downward force is being applied to the dustpan 10, i.e. when the dustpan 10 is in the resting position. However, providing a downward force on the dustpan 10 to move the dustpan 10 to the depressed position, e.g., by depressing the pedal 14 or side members 16 toward the surface 24 as discussed above, helps to firmly establish a complete and/or continuous first area of contact between the dustpan 10 and the surface 24, i.e. between a full length of the blade 20 (from the first contact point 25A to the second contact point 25B) and the surface 24, during cleaning of the surface 24. With this design, a substantial length or the full length of the blade 20 is maintained in firm contact with the surface 24 during use so that the debris being removed from the surface 24 does not get swept underneath the blade 20, i.e. between the blade 20 and the surface 24, during use.

In one embodiment, the blade 20 can be formed from a rubberized material. Alternatively, the blade can be formed from a molded or moldable plastic, from various metallic or composite materials, or from any other suitable materials, which can be similar to or different than the materials used to form the body 12 of the dustpan 10.

The rear support 22 is positioned to connect the pedal 14 with the side members 16 of the dustpan 10. As noted above, the rear support 22, which in certain embodiments constitutes and/or includes the rear most portion of the dustpan 10, includes the third contact point 25C and the fourth contact point 25D of the dustpan 10. Additionally, the third contact point 25C can be at or near one end of the rear support 22, and the fourth contact point 25D can be at or near the other end of the rear support 22. In one embodiment, a center region of the rear support 22, i.e. between the third contact point 25C and the fourth contact point 25D, may be spaced apart from the surface 24. Alternatively, the center region of the rear support 22 may be in substantially continuous contact with the surface 24.

It should be noted that the design of the rear support 22, i.e. the locations of the third contact point 25C and the fourth contact point 25D, should be such that any downward pressure that is applied by the user to the dustpan 10, e.g., on the pedal 14 or the side members 16 toward the surface, occurs substantially between the rear support 22 and the blade 20. Thus, the rear support 22 can be alternatively designed such that the rear support 22 is not the rear most portion of the dustpan 10, so long as the downward pressure is applied substantially between the rear support 22 and the blade 20. Additionally, the locations of the third contact point 25C and the fourth contact point 25D should be such that any downward pressure that is applied to the dustpan 10 occurs substantially between the third contact point 25C and the fourth contact point 25D. Thus, the rear support 22 can be alternatively designed such that the third and fourth contact points 25C, 25D are spaced apart from the ends of the rear support 22, so long as the downward pressure is applied substantially between the third contact point 25C and the fourth contact point 25D.

Further, it should be noted that to the extent that little or no portion of the rear support 22 is spaced apart from the surface 24 between the third and fourth contact points 25C, 25D, providing a downward force on the dustpan 10, e.g., on the pedal 14 or side members 16 as discussed above, helps to firmly establish a complete and/or substantially continuous second area of contact between the dustpan 10 and the surface 24, i.e. between most or all of the entire length of the rear support 22 between the third contact point 25C and the fourth contact point 25D and the surface 24, during cleaning of the surface 24.

Additionally, as discussed herein, when the downward force is provided on the side members 16 and/or the pedal 14, the side members 16, the pedal 14 and/or another portion of the dustpan 10 may flex as needed so that one or both of the blade 20 (i.e. the first area of contact) and the rear support 22 (i.e. the second area of contact) may tend to move slightly along the surface 24 and away from one another in the process of establishing a firmer and/or more continuous contact with the surface 24.

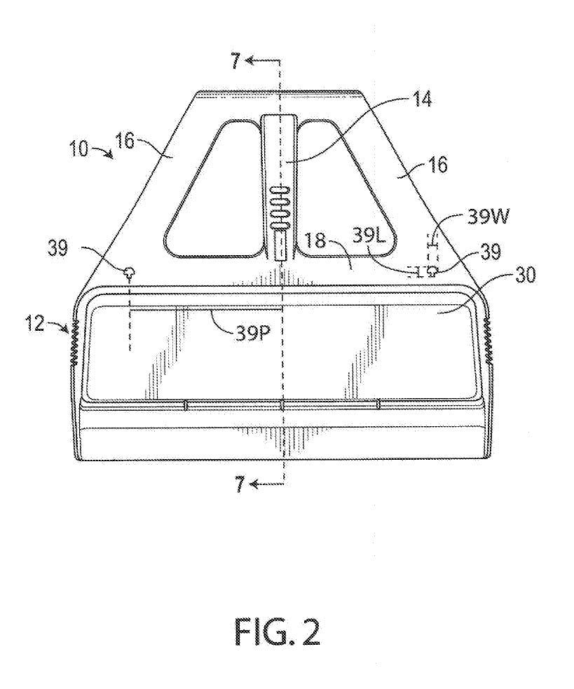

FIG. 2 illustrates how, in this embodiment, the pedal 14 can extend in a generally rearwardly direction substantially perpendicular to the back 30 of the body 12 of the dustpan 10. Additionally, FIG. 2 illustrates how, in this embodiment, the side members 16 can extend in a generally rearwardly direction at an angle away from the back 30 of the body 12 of the dustpan 10, so that the side members are angled toward one another and toward the pedal 14 as the side members extend away from the back 30.

In the embodiment shown in FIG. 2, a pair of connectors 39 are positioned on the cross member 18 at opposing ends. In various alternative embodiments, a plurality of connectors 39 can be positioned on the cross member 18, on the side member 16, and/or a different area on the dustpan 10. In certain embodiments, the connectors 39 can be separate structures that can be attached to a different area of a dustpan with or without connectors on the dustpan. In the embodiment represented in FIG. 2, the connector position 39P can be approximately between one inch and four inches from either side of the line 7-7. More specifically, in certain non-exclusive alternative embodiments, the connector position 39P can be approximately 1.0, 1.5, 2.0, 2.5, 3.0, 3.5, or 4.0 inches from either side of the line 7-7. Still alternatively, the connector position 39P can be another suitable value greater than four inches, less than one inch, or some other value between one inch and four inches. Also illustrated in this embodiment, the connector 39 can have a connector length 39L (as illustrated in FIG. 2), a connector width 39W, and a connector height 39H (as illustrated in FIG. 3). Specifically, the connection width 39W refers to the maximum width of the connector, which is relevant in describing an irregular shaped connector. In the illustrated embodiment of FIG. 2, the connector width 39W refers to the base of the “trapezoid-shaped” portion of the connector 39. In alternative non-exclusive embodiments, the connector 39 can be of any suitable size, depending on the specific requirements of the combination 60.

FIG. 3 illustrates how the full length of the blade 20 can be maintained in contact with the surface 24 during use. As noted above, with this design, this type of more complete contact between the blade 20 and the surface 24 can increase the likelihood that debris being removed from the surface 24 does not get swept underneath the blade 20 i.e. between the blade 20 and the surface 24, during use of the dustpan 10

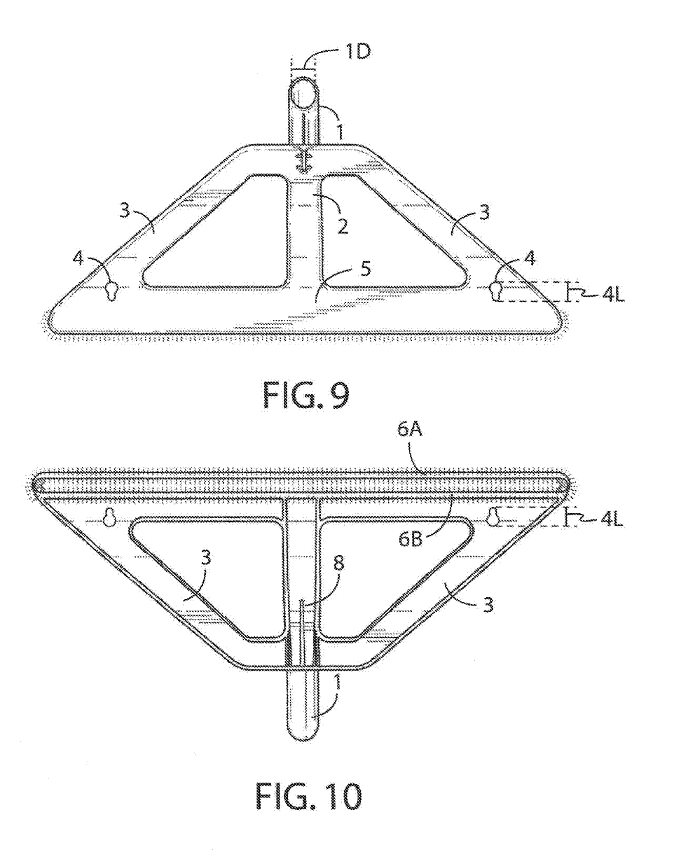

FIG. 3 also illustrates how a pair of connectors 39 is exposed on the surface the dustpan 10. This dustpan design provides a means for establishing a convenient and effortless coupling to the broom housing assembly 50 (illustrated in FIG. 9 and FIG. 15) to lift a dustpan. The connector 39 on dustpan 10 can be of any suitable size, depending on the specific requirements of the combination 60. For example, in certain embodiments, the connector width 39W can be between approximately a quarter inch and a half inch. More specifically, in certain non-exclusive alternative embodiments, the connector width 39W can be approximately 0.25, 0.35, 0.45, 0.5 inches. Still alternatively, the connector width 39W can be another suitable value that is greater than a half inch, less than a quarter inch, or some other value between a quarter inch and a half inch. Further, in certain embodiments, the connector height 39H can be between approximately one inch and five inches. More specifically, in certain non-exclusive alternative embodiments, the connector height 39H can be approximately 1.0, 1.5, 2.0, 2.5, 3.0, 3.5, 4.0, 4.5 or 5.0 inches. Still alternatively, the connector height 39H can be another suitable value that is greater than five inches, less than one inch, or some other value between one inch and five inches.

FIG. 4 is a rear view of the dustpan 10 illustrated in FIG. 1. As shown in FIG. 4, the rear support 22 includes the third contact point 25C and the fourth contact point 25D that can be positioned at or near either end of the rear support 22. Additionally, in this embodiment, the rear support 22 can have a bottom edge 40 that is substantially linear so as to enable a firm and stable area of contact between the rear support 22 and the surface 24 (illustrated in FIG. 3) during use. Alternatively, the rear support 22 can be designed with other than a linear bottom edge 40, so long as the third and fourth contact points 25C, 25D are able to maintain contact with the surface 24 at the same time to ensure a firmer and more stable, i.e. non-wobbly, contact between the rear support 22 and the surface 24 during use.

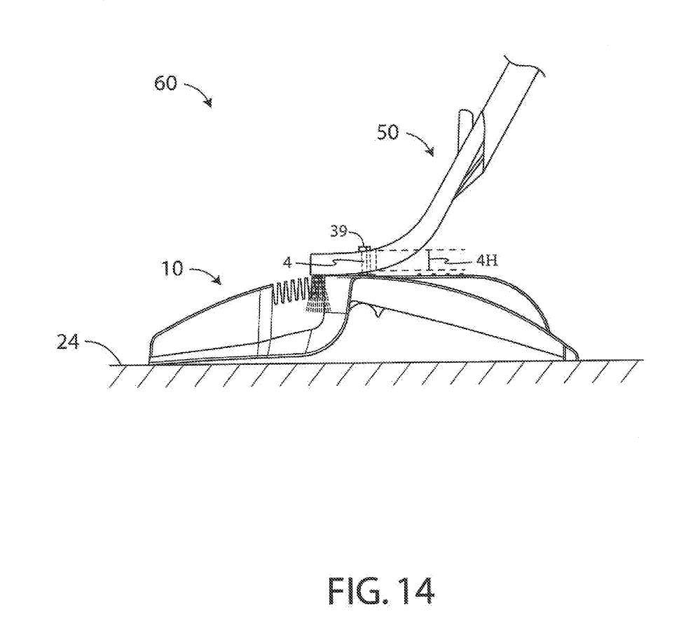

FIG. 4 again illustrates, in an embodiment, how a pair of connectors 39 is exposed on the surface the dustpan 10 for ease of coupling the dustpan 10 to the broom housing assembly 50 (as illustrated in FIG. 8 and FIG. 11) for the purpose of lifting a dustpan. As noted above, the connectors 39 have a width 39W and a height 39H each compatible with the specific requirements of the combination 60 (as illustrated in FIG. 11 and FIG. 14). In various embodiments, a plurality of the connector 39 have a connector width 39W, a connector height 39H, and a connector length 39L.

FIG. 5 is a side view of the dustpan 10 illustrated in FIG. 1, with the dustpan 10 in the resting position. As illustrated in the embodiment in FIG. 5, the blade 20 contacts the surface 24 at a forward most portion of the dustpan 10, and the rear support 22 contacts the surface 24 at a rearward most portion of the dustpan 10. Additionally, as illustrated, when the dustpan 10 is in the resting position, the body 12 of the dustpan 10 extends upward at a slight angle away from the first area of contact between the blade 20 and the surface 24, such that no portion of the body 12 of the dustpan 10 will typically have any contact with the surface 24. Somewhat similarly, as illustrated, the pedal 14 and the side members 16 extend upward at an angle from the rear support, i.e. from the second area of contact between the rear support 22 and the surface 24, such that no portion of the pedal 14 or the side members 16 will typically have any contact with the surface 24.

FIG. 5 also illustrates, in one embodiment, how the connector 39 has a connector height 39H and a connector length 39L. In certain embodiments, the connector length 39L can be between approximately a quarter inch and a half inch. More specifically, in certain non-exclusive alternative embodiments, the connector length 39L can be approximately 0.25, 0.35, 0.45, 0.5 inches. Still alternatively, the connector length 39L can be another suitable value that is greater than a half inch, less than a quarter inch, or some other value between a quarter inch and a half inch. The connector length 39L can be of any suitable size, consistent with the specific requirements of the combination 60 (illustrated in FIG. 14).

Additionally, with the pedal 14 and the side members 16 being spaced apart from the surface 24, when the user provides a downward force on, e.g., steps down on, the pedal 14 and/or one or both of the side members 16, the dustpan 10 will flex downwardly toward the middle of the dustpan 10, e.g., near the cross member 18 that connects the pedal 14 and the side members 16 to the body 12 of the dustpan 10. Further, as the dustpan 10 flexes downwardly toward the middle of the dustpan 10, one or both of the blade 20 (i.e. the first area of contact) and the rear support 22 (i.e. the second area of contact) may tend to move slightly along the surface 24 and away from one another in the process of establishing a firmer contact with the surface 24. With this design, a firm and secure area of contact can be effectively maintained between the blade 20 and the surface 24, and between the rear support 22 and the surface 24, at all times during use of the dustpan 10. Moreover, with such design, the user does not need to bend over and use his/her hand to tilt the blade 20 into the surface 24 as is often required with conventional dustpans.

FIG. 6 is a sectional view of the dustpan 10 taken on line 7-7 in FIG. 2, with the dustpan again in the resting position. More particularly, FIG. 6 illustrates a sectional view that cuts through the center of the pedal 14 of the dustpan 10.

Similar to what is shown in FIG. 5, FIG. 6 also illustrates that the blade 20 establishes the first area of contact with the surface 24 at the forward most portion of the dustpan 10, and that the rear support 22 establishes the second area of contact at the rearward most portion of the dustpan 10.

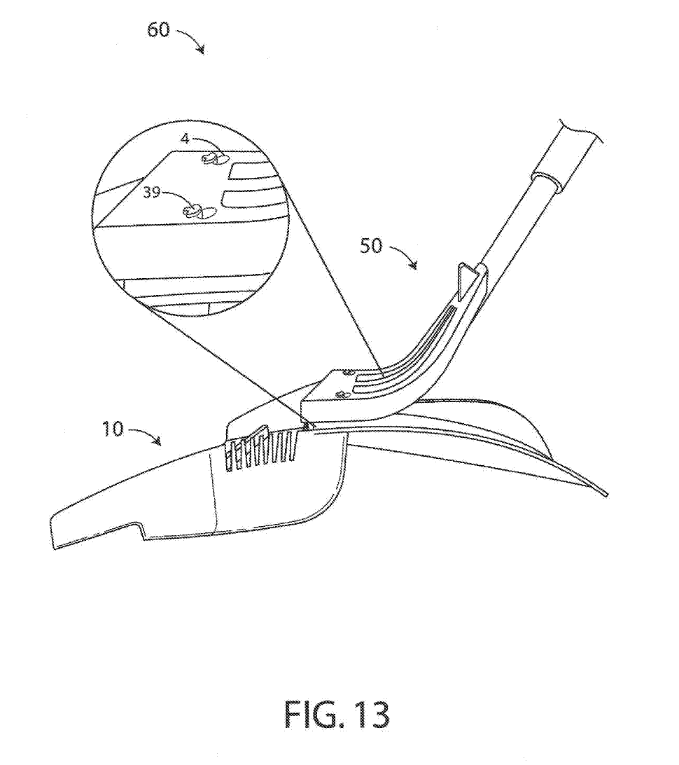

Also, FIG. 6 illustrates how the connector height 39H and the connector length 39L of the dustpan 10 can be values as described above, which are consistent with the requirements of the broom housing assembly 50 (illustrated in FIG. 8) and thereby deemed useful in the combination 60 (as illustrated in FIG. 13).

Additionally, FIG. 6 further illustrates one embodiment for a connection zone 42 between the cross member 18 and the pedal 14 that enables the desired flexing of the dustpan 10 when a downward force is placed on the pedal 14 and/or one or both of the side members 16 during use. Further, the design of the connection zone 42 can absorb at least some of the stress that may otherwise be placed on the cross member 18, the pedal 14, and/or the side members 16, and, thus, inhibit fatigue on the materials used to manufacture the dustpan 10, which may otherwise damage the integrity of the dustpan 10.

FIG. 7 is a side view of the dustpan illustrated in FIG. 1, with the dustpan 10 shown in the depressed position. More particularly, FIG. 7 illustrates that a downward force on the dustpan 10 (illustrated with a downward facing arrow), e.g., on the pedal 14 and/or one or both of the side members 16, has moved the dustpan 10 from the resting position to the depressed position.

FIG. 7 again illustrates that the blade 20 can contact the surface 24 at the forward most portion of the dustpan 10, and the rear support 22 can contact the surface 24 at the rearward most portion of the dustpan 10. Additionally, as illustrated, when the dustpan 10 is in the depressed position, the body 12 of the dustpan 10 has moved downward toward the surface 24 such that at least a portion of the base 26 of the body 12 of the dustpan 10 is in contact with the surface 24. For example, in certain embodiments, when the dustpan 10 is in the depressed position, some or substantially all of the base 26 of the body 12 of the dustpan 10 can be in contact with the surface 24. By having the base 26 of the body 12 of the dustpan 10 contact the surface 24 in such a manner when the dustpan 10 is moved to the depressed position, the dustpan 10 is inhibited from “overflexing” during use, which may otherwise tend to increase fatigue on one or more elements of the dustpan 10. Moreover, the contact between the base 26 and the surface 24 when the dustpan 10 is in the depressed position improves the stability of the dustpan 10 and also helps to more firmly maintain the blade 20 in firm and/or continuous contact with the surface 24 during cleaning of the surface 24.

As shown in FIG. 5 and FIG. 6, FIG. 7 also illustrates that the connector length 39L of the dustpan 10 can be a value as described above, which meets the prerequisites for functioning with the broom housing assembly 50 (FIG. 3) in the combination 60 (as illustrated in FIG. 13).

In certain embodiments, the broom housing assembly 50 can be coupled to a broom handle as described in U.S. Design patent application Ser. No. 29/488,089 issued Jun. 13, 2017 and entitled “Broom Handle” (now U.S. Pat. No. D789,637), the entire disclosure of which is incorporated herein by reference.

FIG. 8-FIG. 14 show multiple embodiments of the broom housing assembly 50, and a bristle assembly shown in phantom. The disclosure of such a bristle assembly is similar to the physical and characteristic properties of the bristle array described in commonly owned U.S. Pat. No. 9,533,206 entitled “Turf maintenance device,” the entire disclosure of which is incorporated herein by reference.

FIG. 8 is a perspective view of an embodiment of a broom housing assembly 50 having features of the present invention. The design of the broom housing assembly 50 can be varied. As shown in FIG. 8, the broom housing assembly 50 includes a socket 1, a center member 2, a pair of side members 3, a pair of apertures 4, a rear member 5, a bottom edge 6A, a head 7, a head support 8, and bristle array. The head 7 and the rear members 5 are coupled to opposing ends of the side members 16 to form the body. The body is coupled to the socket, and a bristle array is coupled to the body. The broom housing assembly 50 includes a means, disposed on the body, for detachably coupling the body to a dustpan.

Alternatively, the broom housing assembly 50 can have a different design. For example in non-exclusive other embodiments, the broom housing assembly 50 can include a different number of the center member 2, i.e. zero, one or more center members 2. In another embodiment, the broom housing assembly 50 can include a different number of the side member 3, i.e. zero, one or more side members 3. In yet another embodiment, the broom housing assembly 50 can include a different number of the apertures 4, i.e. zero, one or more apertures 4, or a combination thereof.

As an overview, the broom housing assembly 50 is uniquely designed to enable the user to easily connect a bristle assembly (illustrated in phantom) with a pole-like broom handle (not illustrated) and to use the tool to effectively swept materials onto the blade 20 of the dustpan 10. The socket 1 of the broom housing assembly 50 can have an upwards biased tip at a specific angle. The specific shape of the socket 1 can better support a pole-like broom handle inserted into the socket 1 and better position the broom handle relative to the surface 24 during use of the broom housing assembly 50. The socket 1 provides a means for coupling between the broom housing assembly 50 and a broom handle. The socket 1 can also be used as a handle. The rear member 5 coupled to the bottom edges 6A and 6B can also form means for attaching the bristle assembly to the broom housing assembly 50. With this design, the broom housing assembly 50 can be more versatile by offering several capabilities including but not limited to: interchanging broom handles of different lengths and interchanging bristle assembly of different bristle density or texture specific for cleaning different surfaces 24 (e.g., tile or wood).

Additionally, the broom housing assembly 50 can provide a means to couple a pole-like handle to the dustpan 10 to form the assembled combination 60 (as illustrated in FIG. 11). The combination 60 can permit effortless and efficient removal of materials from the dustpan 10 simply by lifting and tilting the combination 60 into a collecting receptacle and further the user can maintain a comfortable and convenient upright, standing position during dustpan pickup. This design alleviates the need for the user to have to bend over to pick up the dustpan 10 each time the user wants to empty the contents of the dustpan into another collection receptacle.

Moreover, FIG. 8 illustrates how, in this embodiment, the center member 2 can extend in a generally upwardly direction substantially perpendicular to the rear member 5 of the broom housing assembly 50. Additionally, FIG. 8 also illustrates how, the side members 3 extend in a generally upwardly direction at an angle away from the rear member 5 of the broom housing assembly 50, so that the side members are angled toward one another and toward the center member 2 as the side members extend away from the rear member 5.

In certain embodiments, the broom housing assembly 50 can be formed from a molded or moldable plastic, from various metallic materials, rubberized materials, composite materials, or from other suitable materials. Further, the socket 1, the center member 2, the side members 3, the rear member 5, the bottom edges 6A and 6B (as illustrated in FIG. 10), the head 7, and the head support 8 can be integrally formed so as to avoid any seams within which the dirt and debris may get trapped during use. Alternatively, the broom housing assembly 50 can be manufactured as separate structures, and can be coupled to one or more of the rear member 5, to one or more of the side members 3, or a combination thereof on the broom housing assembly 50 by any suitable manner.

In one embodiment, the rear member 5 can be formed from a moldable plastic. Alternatively, the rear member 5 can be formed from a molded plastic, various metallic materials, rubberized materials, magnets, composite materials, or from other suitable materials, which can be similar to or different than the materials used to form the broom housing assembly 50.

FIG. 8 also illustrates how the rear member 5 can have the aperture 4 that are designed to properly fit around the connector 39 on the dustpan 10, and the aperture 4 offers a means for coupling the broom housing assembly 50 to the dustpan 10. Alternatively, the design of the aperture 4 can be varied to suit the specific design requirements of the dustpan 10 with which the broom housing assembly 50 is being used. As shown in FIG. 8 and in one embodiment, the rear member 5 includes the aperture 4 with the aperture position 4P and the aperture length 4L. In certain embodiments, the aperture position 4P can be between approximately one inch and four inches from either side of the center midline of the broom housing assembly 50. In certain non-exclusive alternative embodiments, the aperture position 4P can be approximately 1.0, 1.5, 2.0, 2.5, 3.0, 3.5, or 4.0 inches from either side of the midline. Still alternatively, the aperture position 4P can be another suitable value that is greater than four inches, less than one inch, or some other value between a one inch and four inches. The aperture position 4P can be of any suitable value, consistent with the specific requirements of the connector position 39P on the dustpan 10, to further enable coupling of the broom housing assembly 50 to the dustpan 10 (illustrated in FIG. 11). Additionally, the aperture 4 can have a different design and/ or the aperture 4 can have a aperture position 4P at a different location on the broom housing assembly 50. Further, the aperture 4 can be formed within the rear member 5 so as to provide a proper coupling for the connector 39 of the dustpan 10 during dustpan pickup for dustpan clearance, i.e. removal of contents on blade 20 of the dustpan 10 into a receptacle. In alternative embodiments, the aperture length 4L can be between approximately a half inch and one inch. More specifically, in certain non-exclusive alternative embodiments, the connector length 39L can be approximately 0.5, 0.6, 0.7, 0.8, 0.9, or 1.0 inch. Still alternatively, the connector length 39L can be another suitable value that is greater than one inch, less than a half inch, or some other value between a half inch and one inch. The connector length 39L can be of any suitable size, consistent with the specific requirements of the combination 60 (illustrated in FIG. 14).

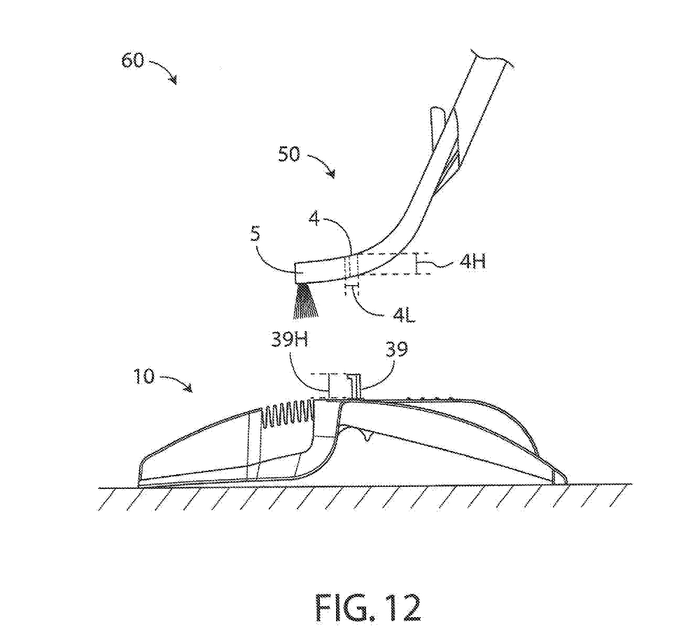

Furthermore, in the embodiment shown in FIG. 8, the aperture 4 that can be varied to suit the specific design requirement of the dustpan 10 with which the broom housing assembly 50 is being used. In various embodiments, the apertures 4 can take on a specific shape that properly fits and accommodates the specific shape of the connector 39 on the dustpan 10 (as illustrated in FIG. 12). In alternative non-limiting embodiments, the aperture 4 of the broom housing assembly 50 can have an inner coating, e.g. metallic material, adhesive material, sticky pads, gel adhesives, rubber cement, or another suitable material that enables the aperture 4 to reversible yet securely couple to the connector 39 (as illustrated in FIG. 12 and FIG. 13).

FIG. 9 is a top view of the broom housing assembly 50 illustrated in FIG. 8, with the bristle assembly shown in phantom. In one embodiment, as shown in FIG. 9, the socket 1 can have a socket diameter 1D. In certain embodiments, the socket diameter 1D can be between approximately one inch and one and a half inches. More specifically, in certain non-exclusive alternative embodiments, the socket diameter 1D can be approximately 1.0, 1.05, 1.1, 1.15, 1.2, 1.25, 1.3. 1.35, 1.4, 1.45, or 1.5 inches. Still alternatively, the socket diameter 1D can be another suitable value that is greater than one and a half inches, less than one inch, or some other value between one inch and one and a half inches. The socket diameter 1D can be of any suitable size, consistent with the specific requirements of a pole-like broom handle with which the broom housing assembly 50 can be used.

FIG. 10 is a bottom view of the broom housing assembly 50 illustrated in FIG. 8, with the bristle assembly shown in phantom. As shown in FIG. 10, in one embodiment, the rear member 5 of the broom housing assembly 50 can connect the bottom edges 6A (front) and 6B (rear), and a bristle assembly can be positioned between the bottom edge 6A and 6B. In certain embodiments, the bottom edges 6A and 6B can have a specific shape designed to secure the bristle assembly in place.

In certain embodiments, the dustpan and broom housing assembly combination 60 may be coupled to the broom handle as described in commonly owned U.S. Pat. No. D789,637), to enable the easy, ergonomic, and efficient removal of materials collected onto the dustpan 10 simply by lifting and turning the broom handle, using one hand, and consequently lifting the combination 60 and dumping the materials into a collection receptacle without the need for the user to bend over and lift the dustpan with his/her hands for each dustpan clearance.

FIG. 11 illustrates how the dustpan 10 can be coupled to the broom housing assembly 50 to form the combination 60 according to an embodiment of the present invention. In one embodiment, as shown in FIG. 11, the combination 60 can comprise a means for coupling the dustpan 10 to the broom housing assembly 50. With this design, the combination 60 enables the effortless and ergonomic remove materials from the dustpan 10 into a receptacle, with the use of one hand to lift the pole-like broom handle for dustpan pickup, and without the need to bend over to lift the rear support 22 of dustpan 10 with his/her hand for each dustpan clearance.

In certain embodiments of the combination 60, the dustpan 10 can be formed from a molded or moldable plastic, from various metallic or rubberized materials, magnets, and/or from other suitable materials which can be similar to or different than the materials used to form the broom housing assembly 50.

FIG. 11 also illustrates how the assembled combination 60 can comprise a means of coupling the dustpan 10 to the broom 50.

In certain embodiments, the combination 60 comprises a means for coupling comprising the socket 1 connected to head 7 of the broom housing assembly 50, which includes the socket diameter 1D, and designed to properly fit, secure, and support a standard broom handle. In other embodiments, the combination 60 comprises a means for coupling comprising a connector 39 of dustpan 10 with a specific shape designed to properly fit into the apertures 4 of the broom housing assembly 50. With this design, the user can efficiently and ergonomically remove materials from the blade 20 of the dustpan 10 while standing in an upright position, without having to bend over and use his/her hand to pick up the rear support 22 of the dustpan 10 (as is often required with conventional dustpans). Also shown in FIG. 11, the assembled combination 60 includes a broom housing assembly coupled to a bristle array that is positioned immediately against the back 30 of dustpan 10.

Further, in alternative non-exclusive embodiments, the dustpan 10 is coupled to the broom 50 via magnets. For example, the cross member 18 of dustpan 10 comprises a magnet with a positive (or negative) polarity and the rear member 5 of the broom housing 50, comprises a magnet with a negative (or positive) polarity opposite to the polarity of the dustpan 10 to form the assembled combination 60. Alternatively, in other embodiments, the cross member 18 of dustpan 10 is coated with a transient adhesive on the bottom side of the cross member 18, which can be coupled to the rear member 5 of the broom housing 50 to form the assembled combination 60. Alternatively, the bottom side of the rear member 5 of the broom housing 50 is coated with a transient adhesive instead of the cross member 18 of dustpan 10. Use of a transient adhesive or a means of reversible attachment (e.g., gel adhesive, double-stick tape, rubber cement, velcro, or other comparable materials) is to enable the coupling and decoupling of the dustpan 10 and broom housing assembly 50.

FIG. 12 illustrates a side view of the unassembled dustpan and broom housing assembly combination 60, showing in phantom the aperture 4 on the broom housing assembly 50 for the connector 39 on the dustpan 10, according to an embodiment of the present invention. FIG. 12 illustrates, in one embodiment, how a means for coupling the dustpan 10 to the broom housing assembly 50 can comprise a pair of connectors 39 with connector length 39L and connector height 39H consistent with the requirements to properly fit into the aperture 4. The design of the combination 60 enables easy, ergonomic, and efficient dustpan pick up without having to bend over and use a hand to pick up the rear support 22 of the dustpan 10 (as is often required with conventional dustpans) to remove materials from the blade 20 of the dustpan 10 into a receptacle for every dustpan clearance. In alternative embodiments, the means for coupling

FIG. 13 illustrates a sectional view of the assembled dustpan and broom housing assembly combination 60, showing an enlarged view of the aperture 4 coupled to the connector 39, according to an embodiment of the present invention.

FIG. 14 illustrates another sectional view of the assembled dustpan and broom housing assembly combination 60 according to an embodiment of the present invention. Further, FIG. 14 illustrates how in the assembled combination 60, the aperture 4 of the broom housing assembly 50 can be aligned over the connector 39 of the dustpan 10 and downward pressure can be applied until the connector 39 is properly inserted to form a means of coupling. Alternatively, upward pulling force on the broom housing assembly 50 sufficient to separate or decouple the aperture 4 from the connector 39 can produce the unassembled combination 60 as shown in FIG. 12. Furthermore, the combination 60 can comprise a means for coupling the dustpan 10 to the broom housing assembly 50, wherein the apertures 4 receive the connector 39. Alternatively, the combination 60 can comprise a means for coupling the broom housing assembly 50 to the dustpan 10, wherein the connectors 39 receive the apertures 4. In various embodiments, the means for coupling comprises a connector 39 having a specific shape designed to be inserted into the aperture 4 having a complimentary shape that permits the connector 39 to be passed upward through the aperture 4 and then moved With this design, the means for coupling enables the user to lift a dustpan from a surface while in an upright, standing position.

While a number of exemplary aspects and embodiments of a dustpan and broom housing assembly combination 50 have been shown and disclosed herein above, those of skill in the art will recognize certain modifications, permutations, additions and sub-combinations thereof. It is therefore intended that the combination 60 shall be interpreted to include all such modifications, permutations, additions and sub-combinations as are within their true spirit and scope, and no limitations are intended to the details of construction or design herein shown.

We claim:

1. A dustpan comprising:
a body, and a cross member coupled to the body,
means, disposed on the cross member, for detachably coupling the dustpan to a broom.

2. The dustpan of claim 1, wherein the means for detachably coupling comprises a plurality of connectors.

3. The dustpan of claim 2, wherein each of the plurality of connectors comprises a mushroom shaped head and a stem.

4. The dustpan of claim 3, wherein each of the plurality of connectors are disposed on opposing ends of the cross member.

5. The dustpan of claim 4, wherein each of the plurality of connectors is integrally formed with the cross member.

6. The dustpan of claim 4, wherein each of the plurality of connectors is formed as a separate structure from the cross member.

7. The dustpan of claim 1, wherein the means for detachably coupling comprises an adhesive coating.

8. The dustpan of claim 1, wherein the means for detachably coupling comprises a magnet.

9. A broom comprising:
a socket, a body coupled to the socket, and a bristle array coupled to the body; and
a means, disposed on the body, for detachably coupling the body to a dustpan.

10. The broom of claim 9, wherein the means for detachably coupling comprises a plurality of apertures.

11. The broom of claim 10, wherein each of the apertures comprises a circular portion and a slot portion.

12. The broom of claim 10, wherein the plurality of apertures are disposed on a portion of the body adjacent to the bristle array.

13. The broom of claim 9, wherein the means for detachably coupling comprises an adhesive coating.

14. The broom of claim 9, wherein the means for detachably coupling comprises a magnet.

15. A broom and dustpan system comprising:
a dustpan;
a broom;
wherein the dustpan and broom comprise a means for detachably coupling the dustpan and the broom together.

16. The system of claim 16, wherein the means for detachably coupling the dustpan and the broom together comprises a plurality of connectors and a plurality of apertures.

17. The system of claim 17, wherein each of the plurality of connectors comprises a mushroom shaped head and a stem, and each of the apertures comprises a circular portion and a slot portion.

18. The system of claim 16, wherein the means for detachably coupling the dustpan and the broom together comprises one or more adhesive coatings.

19. The system of claim 16, wherein the means for detachably coupling the dustpan and the broom together comprises one or more magnets.
